(19) United States
(12) Patent Application Publication
(10) Pub. No.: US 2011/0055121 A1
(43) Pub. Date: Mar. 3, 2011

(54) SYSTEM AND METHOD FOR IDENTIFYING AN OBSERVED PHENEMENON

(76) Inventors: Ankur Datta, Pittsburgh, PA (US); Kevin Myungho Yoon, Pittsburgh, PA (US); Sajid Mahmood Siddiqi, Pittsburgh, PA (US); Michael Scott Bauer, Sewickley, PA (US); Abhishek SHARMA, Pittsburgh, PA (US)

(21) Appl. No.: 12/240,796

(22) Filed: Sep. 29, 2008

(51) Int. Cl. G06N 5/02; G06F 15/18

(52) U.S. Cl. 706/12; 706/52

(57) ABSTRACT

A system for identifying an observed phenomenon. The system includes a computing device configured for receiving disparate data streams associated with disparate data sources. The system also includes a feature extraction module communicably connected to the computing device, a classification module communicably connected to the computing device, and a consensus module communicably connected to the computing device. The feature extraction module is configured for generating a set of attributes for each data stream. The classification module is configured for soft associating labels with attributes for each set of attributes, and for generating a confidence value for each soft association. The consensus module is configured for generating an output indicative of the phenomenon. The consensus module includes a standardization module and a sequential data module. The standardization module is configured for standardizing the confidence values. The sequential data module is configured for generating the output based on the standardized confidence values.

### CROSS-REFERENCE TO RELATED APPLICATION

This application is related to U.S. patent application Ser. No. 11/644,319 filed on Dec. 22, 2006.

### BACKGROUND

This application discloses an invention which is related, generally and in various embodiments, to a system and method for identifying an observed phenomenon.

Supervised, semi-supervised and unsupervised learning and inference of relevant events in complex, dynamic and evolving environments is a challenging task. Systems that can successfully accomplish this task require very rich, efficient, effective and more importantly computationally tractable (having linear or logarithmic time performance) algorithms that manipulate both passive and active information obtained from disparate data sources.

Sensors or transducers are one of the most reliable data sources to perceive a complex environment and phenomena occurring in that environment. Unfortunately, sensors by themselves can only provide measurement of variables in that environment. These variables have to be processed and transformed into signatures indicative of the underlying phenomenon or event(s). This process is generally referred as synergy.

While a single sensor can be manipulated to capture various variables of the environment, the quality of output from synergy process (i.e. information) can be enhanced significantly by using multiple sensors. Generally, use of more than one sensor enhances synergistic effect in several ways, including, increased spatial and temporal coverage, increased robustness to sensor and algorithmic failures, better noise suppression, increased estimation accuracy, and increased ability to capture more uncertainty.

Synergy for multiple sensors is fairly comprehensive and can be applied on various dimensions such as data, attributes, domains or timesteps. Synergy across attributes provides a way to capture multiple signatures of the underlying phenomenon amidst heavy ambiguity, noise or uncertainty. This configuration allows use of a number of data sources to measure different quantities associated with the same phenomenon.

Synergy across attributes has been implemented using several frameworks, and one very widely used is the Joint Directors of Laboratories (JDL) data fusion model. Designed very specifically for the military, this model has a hierarchical architecture that incorporates multiple signatures (either from sensors or data sources) and it performs step by step processing to provide a unified consolidated estimate about the underlying phenomenon.

Variants of the JDL architecture have been used in several practical applications outside the military, including one for automotive safety. Even though JDL provides a rich framework, it still has several limitations and some inherent shortcomings, especially for building practical real-time systems.

One limitation/shortcoming of JDL is that the architecture relies heavily on aligned data from various sensors and data sources. The reliance on aligned data leads to heavy post-processing such as noise removal, spatial and temporal transformations etc. Another limitation/shortcoming of JDL is that the architecture relies on a signature or a knowledge database of known events and objects, and uses a search methodology to perform assessment of the phenomenon. Yet another limitation/shortcoming of JDL is that the architecture does not possess an ability to continuously learn and adapt by directly using feedback from the end-user. Additionally, with JDL, there is a lack of modularity, real-time performance, and ability to easily tune the system for detecting new events and new objects in new environments. JDL

### SUMMARY

In one general respect, this application discloses a system for identifying an observed phenomenon. According to various embodiments, the system includes a computing device configured for receiving disparate data streams associated with disparate data sources. The system also includes a feature extraction module communicably connected to the computing device, a classification module communicably connected to the computing device, and a consensus module communicably connected to the computing device. The feature extraction module is configured for generating a set of attributes for each data stream. The classification module is configured for soft associating labels with attributes for each set of attributes, and for generating a confidence value for each soft association. The consensus module is configured for generating an output indicative of the phenomenon. The consensus module includes a standardization module and a sequential data module. The standardization module is configured for standardizing the confidence values. The sequential data module is configured for generating the output based on the standardized confidence values.

In another general respect, this application discloses a method, implemented at least in part by a computing device, for identifying an observed phenomenon. According to various embodiments, the method includes receiving disparate data streams associated with disparate data sources, generating a set of attributes for each data stream, soft associating labels with attributes for each set of attributes, generating a confidence value for each soft association, standardizing the confidence values, and generating an output indicative of the phenomenon based on the standardized confidence values.

Aspects of the invention may be implemented by a computing device and/or a computer program stored on a computer-readable medium. The computer-readable medium may comprise a disk, a device, and/or a propagated signal.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system for identifying an observed phenomenon;

FIG. 2 illustrates various embodiments of a consensus module of the system of FIG. 1;

FIG. 3 illustrates various embodiments of a sequential data module of the consensus module of FIG. 2; and

FIG. 4 illustrates various embodiment of a method for identifying an observed phenomenon.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

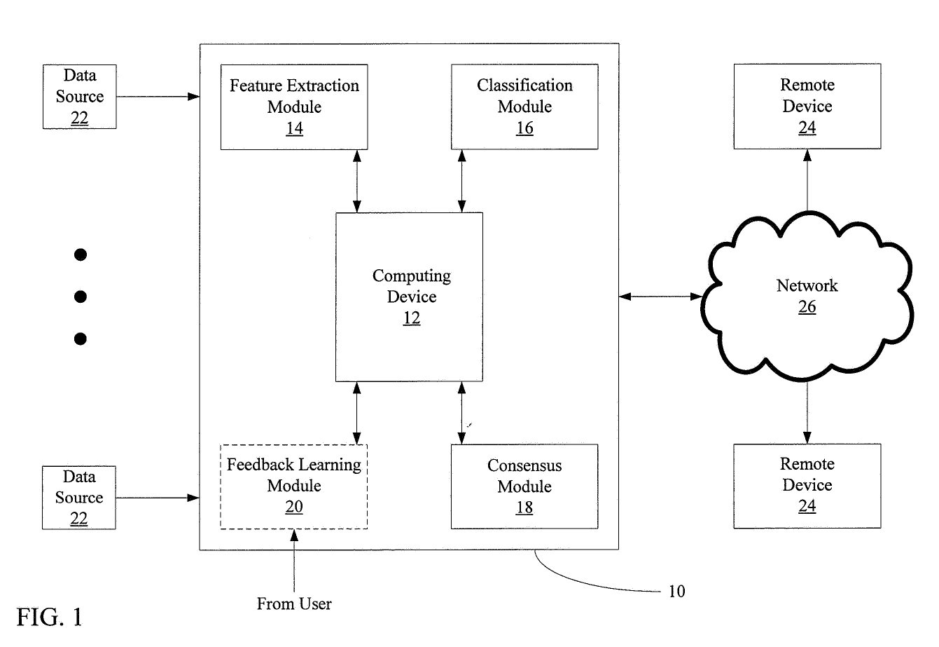

FIG. 1 illustrates various embodiments of a system 10 for identifying an observed phenomenon. The phenomenon may any suitable type of phenomenon. For example, according to various embodiments, the phenomenon is the presence of a human in a sensed environment. The system 10 includes a computing device 12, a feature extraction module 14 communicably connected to the computing device 12, a classification module 16 communicably connected to the computing device 12, and a consensus module 18 communicably connected to the computing device 12. As shown in FIG. 1, according to various embodiments, the system 10 may also include a feedback learning module 20 communicably connected to the computing device 12. The computing device 12 may be any suitable type of computing device configured for receiving data, and for executing instructions to process the data. Each of the modules 14-20 will be described in more detail hereinbelow.

The system 10 is configured for receiving data streams from disparate data sources, and for identifying one or more phenomena based on the received data. As explained in more detail hereinbelow, the data streams may be associated with a sensed environment and may be utilized to indicate the presence or non-presence of a phenomenon in the sensed environment. The system 10 may be utilized to identify phenomena for a wide range of applications. Such applications may include, for example, monitoring, surveillance, asset tracking and monitoring, physiological and health monitoring, fraud detection, collision detection amongst vehicles, crop yield predictions, etc.

As shown in FIG. 1, the system 10 may be communicably connected to a plurality of disparate data sources 22. In general, the system 10 includes multiple input terminals, and each input terminal is configured to receive a data stream from an individual data source 22. The data sources 22 may be communicably connected to the system 10 in any suitable manner (e.g., wired or wireless). The data sources 22 may include any suitable type of data sources such as, for example, analog sensors, analog transducers, digital sensors, digital transducers, electronic devices, static data sources, etc. According to various embodiments, the data sources 22 include one or more of the following: a camera, a microphone, a motion detector, a temperature sensor, a thermal imager, a gauss detector, a humidity detector, a magnetometer, a tri-axis accelerometer, a tri-axis gyroscope, a seismic sensor, a vibration sensor, a sonar sensor, a radar sensor, a microwave oven, a video camera recorder, a laser compact disk player, a repository of text files, a repository of images, and a repository of sound files. The data provided by the data sources 22 may be provided in diverse formats, ranging from analog and digital signals to extensible markup language (XML).

The system 10 may also be communicably connected to a plurality of remote devices 24. The system 10 may be connected to one or more remote devices 24 via a wired or wireless pathway, or as shown in FIG. 1, may be connected via a network 26 having wired or wireless data pathways. The remote devices 24 may be embodied as personal computers having a display screen, as laptop computers, etc. The network 26 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. The network 26 may include elements, such as, for example, intermediate nodes, proxy servers, routers, switches, and adapters configured to direct and/or deliver data. In general, the system 10 may be structured and arranged to communicate with the remote user devices 24 via the network 26 using various communication protocols (e.g., HTTP, TCP/IP, UDP, WAP, WiFi, Bluetooth) and/or to operate within or in concert with one or more other communications systems.

The feature extraction module 14 is configured for generating a set of attributes for each data stream received by the system 10. Such attributes may include, for example, a set of transformed data associated with one of the data streams, statistics generated from the entirety of a set of the transformed data, statistics generated from a portion of a set of transformed data, etc. The transformed data may be considered a signature of a phenomenon. For example, the transform of a given analog waveform provided by a microphone may be a signature of human speech. Statistical attributes may include values for a mean, a variance, a centroid, a moment, an energy, an energy density, a correlation, a spectral roll off, an entropy, etc. According to various embodiments, the attributes may be represented in the form of a matrix (e.g., a 5×1000 matrix). As described hereinabove, the data from the disparate data sources 22 may be in different formats. Therefore, according to various embodiments, the feature extraction module 14 is configured to apply a set of transforms to the data received from the disparate data sources 22 prior to generating the set of attributes. Such transforms may include, for example, any of a variety of spatial transforms, temporal transforms, and frequency based transforms. Thus, the applied transforms may include, for example, linear transforms, non-linear transforms, Fourier transforms, wavelet transforms, auto-regressive models, state estimators (e.g., Kalman filters, particle filters, etc.), sub-space coding, and the like. For data sources 22 which provide image data, the transforms may be spatial and/or temporal transforms that operate on pixel values.

In some implementations, the generated attributes may include a certain amount of redundancy. In order to reduce and/or eliminate the redundancy, according to various embodiments, the feature extraction module 14 is further configured to apply a linear dimensionality reduction algorithm and/or a non-linear dimensionality reduction algorithm to the generated attributes. Such dimensionality reduction algorithms may include, for example, principal component analysis algorithms, independent component analysis algorithms, Fisher analysis algorithms, algorithms for fitting a non-linear manifold, etc. The application of the dimensionality reduction algorithms allows the generated set of attributes to be represented in the form of a reduced matrix (e.g., a 5×1 matrix).

The classification module 16 is configured for soft associating pre-defined labels with attributes for each set of attributes generated by the feature extraction module 14. As the attributes are associated with the data streams, which in turn are associated with the observed phenomenon, the labels may be considered to be soft associated with the observed phenomenon. Such labels may include, for example, human speech, non-human speech, human face, non-human face, human gait, non-human gait, human, non-human, dog, cat, bird, etc. The classification module 16 includes a plurality of classifiers which are utilized to soft associate the labels. Each attribute may be soft associated with any number of labels, and each label may be soft associated with any number of attributes. Prior to its full implementation, the classification module 16 may be trained by manually collecting numerous examples of data from various data sources, soft associating attributes of the data with known labels, and determining which classifiers are most appropriate for each data source. For example, it may be determined that a hidden Markov model-based speech recognizer may be the optimal way to model audio data, a color histogram plus support vector machine-based classifier may be the optimal way to model video data, etc. Each classifier of the classification module 16 may be associated with a different input terminal/port of the system 10. By knowing which input terminal a given classifier is associated with, the classifier may be automatically matched to the appropriate data stream when the data source 22 which generates the data stream is communicably connected to the input terminal.

In general, the classification performed by the classification module 16 is discriminatory in that each label is classified as either “yes” or “no”, “+” or “−”, etc. with respect to each attribute. The “yes” or “no” classification may be based on which side of a decision boundary the label is positioned. The classification module 16 may utilize any suitable methodology to classify the labels. For example, according to various embodiments, the classification module 16 may apply parametric or nonparametric models such as regression algorithms, support vector machine and kernal algorithms, Markov algorithms, Gaussian mixture algorithms, Kalman algorithms, neural networks, random fields algorithms, statistical machine learning methods, etc. to classify the labels.

The classification module 16 is also configured for generating a confidence value for each soft association. The confidence values may be determined in any suitable manner. For example, according to various embodiments, a given confidence value is a representation of a distance (e.g., euclidian distance, statistical distance, etc.) that the label is from the decision boundary.

The consensus module 18 is configured for standardizing the confidence values, and generating an output indicative of the phenomenon (e.g., the presence of a dog in a sensed environment) based on the standardized confidence values. The output may be in any suitable form. For example, according to various embodiments, the output may include a label (e.g., dog) and a corresponding likelihood (e.g.,85, 85%, etc.) that the label is indicative of the phenomenon. The likelihood represents how many times it is more likely than not that the label is indicative of the phenomenon. For example, for an output of a label (e.g., dog) having a likelihood of 71%, it is seventy-one times more likely than not that the observed phenomenon is a dog. As some labels and their corresponding confidence values may be contradictory to other labels and their corresponding confidence values, the output generated by the consensus module 18 may be considered a consensus between the various labels and corresponding confidence values.

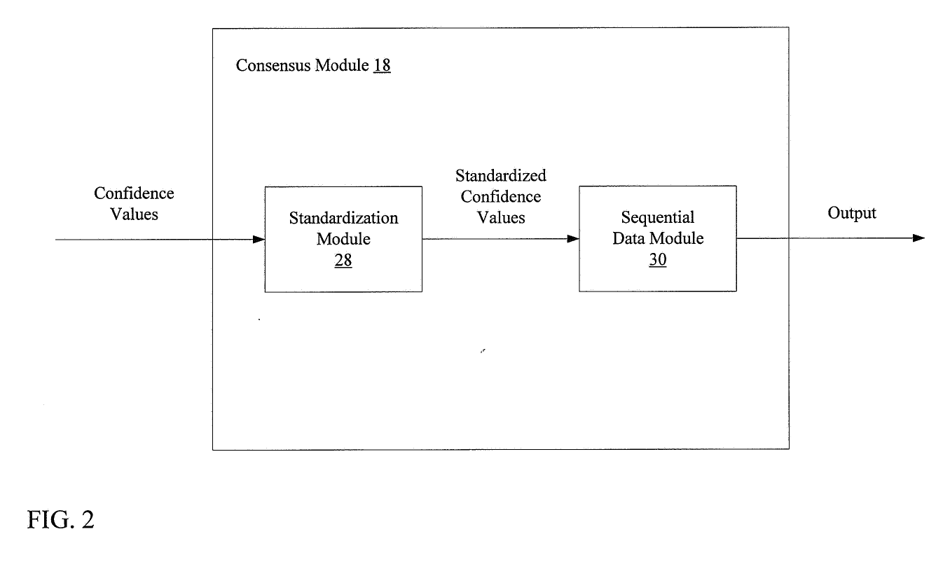

As shown in FIG. 2, according to various embodiments, the consensus module 18 includes a standardization module 28 and a sequential data module 30. The standardization module 28 is configured for standardizing the confidence values of the labels for each soft association. The standardization module 28 may utilize any suitable methodology to standardize the confidence values. For example, according to various embodiments, the standardization module 28 applies a sigmoid function to transform the confidence values to values in the interval [0, 1]. As each label and corresponding confidence value generated by the classification module 16 may be produced by a different classifier with its own unique set of parameters, the standardization of the confidence values by the consensus module 18 allows for the labels to be accurately compared to one another. Collectively, the standardized confidence values associated with data received from the data sources 22 during a given time period define a standardized data point at a given time step.

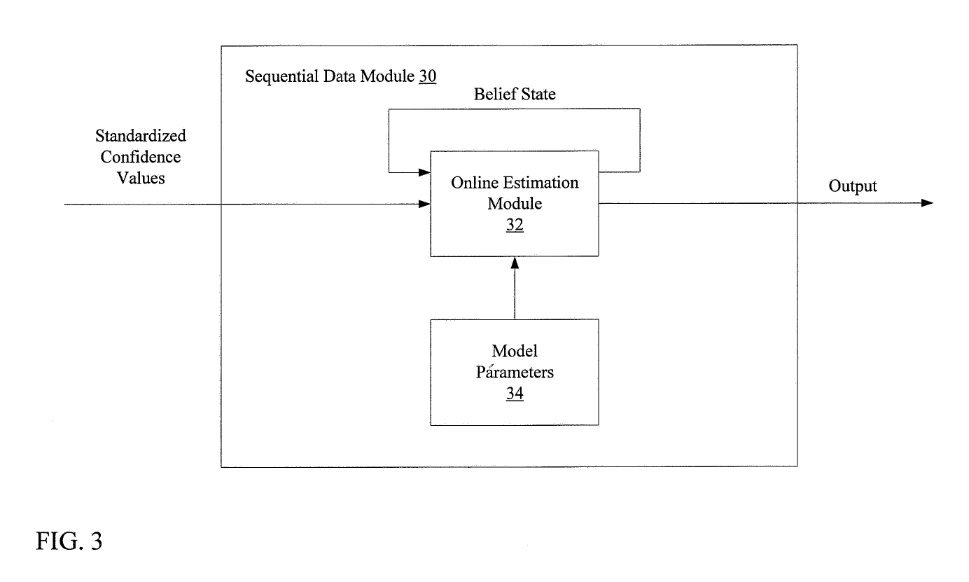

The sequential data module 30 is communicably connected to the standardization module 28. The sequential data module 30 is configured for receiving a sequence of standardized confidence values (i.e., standardized data points) generated by the standardization module 28, and for generating the output based on the standardized confidence values. As shown in FIG. 3, the sequential data module 30 includes an online estimation module 32, and one or more model parameters 34 which are utilized by the online estimation module 32 to generate the output. The model parameters 34 may include any suitable type of parameter. For example, according to various embodiments, the model parameters 34 include the number of pre-defined labels, how the labels are connected, distributions for the respective labels, etc. Prior to the full implementation of the sequential data module 30, each model parameter 34 may be trained to recognize a distribution for each label. The model parameters 34 may be trained in any suitable manner. For example, according to various embodiments, the model parameters 34 are trained using statistical machine learning techniques.

According to various embodiments, the sequential data module 30 includes different model parameters for each possible value of the output. For example, a first model parameter may be utilized to recognize the presence of a dog, and a second model parameter may be utilized to recognize the absence of a dog (or the presence of a non-dog). According to other embodiments, the sequential data module 30 includes a single model parameter with different states for each possible value of the output. For example, state “A” may be an indication of the presence of a dog, and state “B” may be an indication of the absence of a dog.

The feedback learning module 20 is configured for receiving input from a user, and for utilizing such input to initiate at least one of the following: modifying the standardization module 28, modifying at least one of the model parameters 34 of the consensus module 18, and replacing a compromised data source 22. According to various embodiments, the modification (i.e., retraining) of the model parameters is performed offline. According to other embodiments, the retraining is performed online. The input may be “positive” or “negative” based on the output as judged by the user. According to various embodiments, a “positive” input is indicative of a “correct” output, and a “negative” input is indicative of a “non-correct” output. A positive input operates to increase the likelihood factor of a subsequent output when the same data is subsequently received from the data sources 22. A negative input operates to decrease the likelihood factor of a subsequent output when the same data is subsequently received from the data sources 22. The feedback learning module 20 may utilize any suitable methodology for retraining the model parameters 34. For example, according to various embodiments, the feedback learning module 20 may utilize committee-based methods from the machine learning field of active learning. According to other embodiments, the feedback learning module 20 may utilize concepts from the field of information theory such as entropy and information gain.

The modules 14-20 and 28-32 may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The modules 14-20 and 28-32 (e.g., software application, computer program) may be stored on a computer-readable medium (e.g., disk, device, and/or propagated signal) such that when a computer reads the medium, the functions described herein are performed.

According to various embodiments, the modules 14-20 and 28-32 may reside at the computing device 12, at other devices within the system 10, or combinations thereof. For embodiments where the system 10 includes more than one computing device 12, the modules 14-20 and 28-32 may be distributed across the plurality of computing devices 12. According to various embodiments, the functionality of the modules 14-20 and 28-32 may be combined into fewer modules (e.g., a single module).

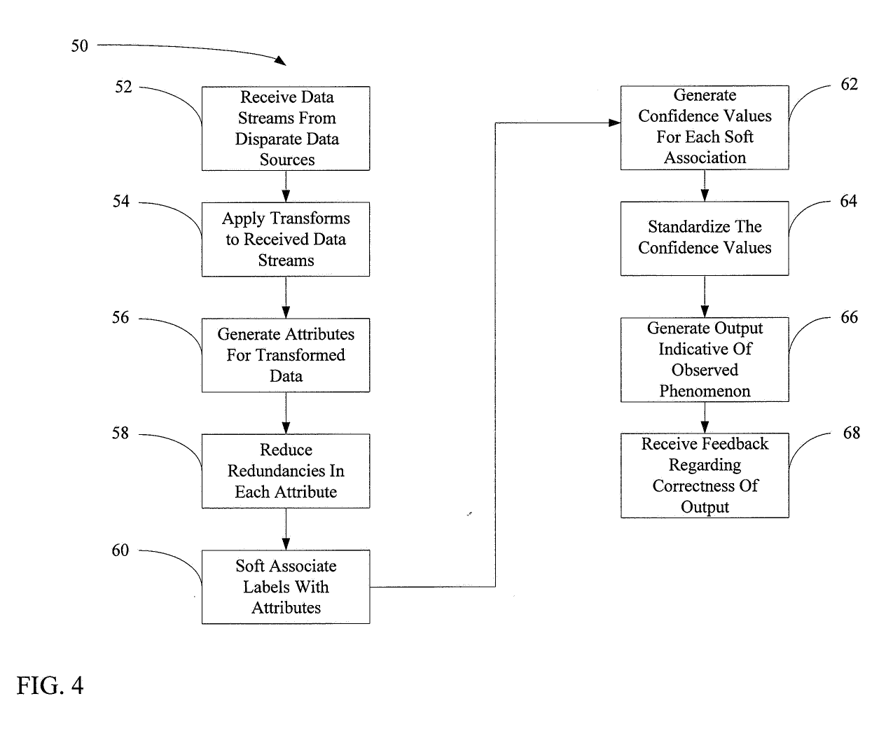

FIG. 4 illustrates various embodiments of a method 50, implemented at least in part by a computing device, for identifying an observed phenomenon. The method 50 may be implemented by the system 10 of FIG. 1. For ease of explanation purposes, the method 50 will be described in the context of its implementation by the system 10 of FIG. 1. Prior to the start of the process 50, the classification module 16 and the model parameters 34 of the consensus module 18 may be trained in the manner described hereinabove.

The process starts at block 52, where the system 10 receives data streams from each of the plurality of disparate data sources 22. The different data streams from the different data sources 22 may be received concurrently, and may be received in a continuous manner. Thus, the system 10 may be receiving, for example, ten, one-hundred, one-thousand, etc. different data streams at the same time. As some data sources 22 may be different from the other data sources 22, the received data streams may be in a variety of different formats.

From block 52, the process advances to block 54, where the feature extraction module 14 applies one or more transforms to the received data streams. Different transforms may be applied to different data streams. For example, a first type of transform may be applied to the data stream associated with a first one of the data sources 22, a second type of transform may be applied to the data stream associated with a second one of the data sources 22, a third type of transform may be applied to the data stream associated with a third one of the data sources 22, etc. In general, the type of transform applied depends on the type of data source 22 associated with the data stream. The system 10 may be pre-programmed to apply a particular transform to a particular data stream based on which input terminal of the system 10 the data source 22 associated with the data stream is communicably connected to. For each data stream to which a transform is applied, the resultant product may be considered a set of transformed data.

From block 54, the process advances to block 56, where the feature extraction module 14 generates a set of attributes for each set of transformed data. As each set of transformed data is associated with a particular data stream from a particular data source 22, each set of attributes is also associated with a particular data stream and a particular data source 22. The attributes may be any suitable type of attributes. For example, according to various embodiments, a set of transformed data is considered an attribute. According to other embodiments, the attributes are statistics generated from the entirety of a set of the transformed data. According to yet other embodiments, the attributes are statistics generated from a portion of a set of transformed data.

From block 56, the process advances to block 58, where the feature extraction module 14 reduces any redundancies in each attribute. The redundancies may be reduced in any suitable manner. In general, the feature extraction module 14 may utilize any suitable linear and/or nonlinear dimensionality reduction technique to reduce any redundancies in the attributes. For example, according to various embodiments, the feature extraction module 14 applies principal component analysis to the attributes to reduce any redundancies. According to other embodiments, the feature extraction module 14 applies individual component analysis to the attributes to reduce any redundancies. According to yet other embodiments, the feature extraction module 14 applies Fisher analysis to the attributes to reduce any redundancies. According to yet other embodiments, the feature extraction module 14 utilizes the fitting of a nonlinear manifold to reduce any redundancies in the attributes.

From block 58, the process advances to block 60, where the classification module 16 classifies each set of attributes by soft-associating pre-defined labels with attributes. As each set of attributes is associated with a particular data stream from a particular data source 22, each soft-association is also associated with a particular data stream and a particular data source 22. The classification module 16 may soft-associate the attributes with the labels in any suitable manner. For example, according to various embodiments, the classification module 16 may utilize one or more parametric models to realize the soft-associations. According to other embodiments, the classification module 16 may utilize one or more nonparametric models to realize the soft-associations. A given label can be soft-associated with more than one attribute, and a given attribute can be soft-associated with more than one label. For example, a given attribute may be soft-associated with the following labels: dog, cat, and bird. As the attributes are associated with the data streams received from the data sources 22, the labels are also soft-associated with the received data streams. In general, the type of trained classifier applied to a given attribute by the classification module 16 depends on the type of data source 22 associated with the attribute. The classification module 16 may be pre-programmed to apply a given trained classifier to a given attribute based on which input terminal of the system 10 the data source 22 associated with the given attribute is communicably connected to.

From block 60, the process advances to block 62, where the classification module 16 generates a confidence value for each soft-association. As each soft-association is associated with a particular data stream from a particular data source 22, each confidence value is also associated with a particular data stream and a particular data source 22. The confidence values may be generated in any suitable manner. For example, according to various embodiments, a given confidence value may be generated based on the distance a given attribute lies from a decision boundary. In general, the confidence values are indicative of the correctness of the soft-association. The confidence values may be represented in any suitable manner. For example, according to various embodiments, each confidence value may be represented as a probability distribution, a percentage, etc. For the above-example where the soft-associated labels for a given attribute include dog, cat, and bird, the respective labels and confidence values may be represented as 70% dog, 25% cat, and 5% bird. According to various embodiments, the actions described at blocks 60 and 62 may be performed concurrently.

From block 62, the process advances to block 64, where the standardization module 28 of the consensus module 18 receives the respective labels and the corresponding confidence values, and standardizes the confidence values. The confidence values are standardized on a data stream by data stream basis, and the standardization may be realized in any suitable manner. For example, according to various embodiments, the standardized confidence values for the labels associated with a given data stream are generated by applying a sigmoid function to the non-standardized confidence values. At the completion of the actions described at block 62, the totality of the labels associated with a given data stream may have an overall confidence value between zero and one. According to various embodiments, the totality of the labels and overall confidence values associated with the different data streams is represented as a single vector (e.g., a standardized datapoint at a given timestep). The process described at blocks 52-64 may be repeated on an ongoing basis so that a sequential stream of standardized datapoints are generated.

From block 64, the process advances to block 66, where the sequential data module 30 generates a sequence of outputs based on the sequence of standardized datapoints. Each output is an indication of the phenomenon. The outputs may be in any suitable form, and may be generated in any suitable manner. According to various embodiments, the outputs are generated in a three-step process. First, the online estimation module 32 compares the vector to learned distributions for each label (e.g., model parameters 34). The comparisons may be made in any suitable manner, and are utilized to determine how likely the vector is to belong to a given label. For the example where the labels are dog, cat, and bird, the comparison may be utilized to determine that it is 90% likely that the vector belongs to the dog label, 8% likely that the vector belongs to the cat label, and 2% likely that the vector belongs to the bird label. Each label may be associated with a different state of the sequential data module 30, and the sequential data module 30 may be considered to be in the state having the highest determined likelihood. For the above example, the sequential data module 30 would be considered to be in the “dog” state.

Second, the online estimation module 32 compares the most recently determined state with a determined state from the previous time period, or with determined states from previous consecutive time periods. The comparisons may be made in any suitable manner. According to various embodiments, the comparisons are utilized to determine how likely the current state is the same as the previous state (i.e., state likelihood), and for each other state, how likely the other state was the previous state (i.e., transition likelihood). For embodiments where the estimation module 32 looks back further in time, the comparisons are utilized to determine how likely the current state is the same as the previous states for a given number of time periods, and for each other state, how likely the other state was the previous state for each of the given time periods. The various likelihoods (e.g., parameter models 34) may have different values/probabilities, and the respective values/probabilities may be included in a transition matrix which is included in the model parameters 34. Therefore, the transition matrix may represent the change from a previous state of a given time period to the current state , or changes from previous states of given time periods to the current state.

Third, the online estimation module 32 determines a final value for each label. The final value may be determined in any suitable manner. According to various embodiments, the final value for each label is determined by multiplying the state likelihood of a given label by the transition likelihood of the given label. Once a final value has been determined for each label, the online estimation module 32 may output each label and the corresponding final values, or may simply output the label having the highest final value (e.g., dog 0.94). The label and the corresponding final value (or the labels and the corresponding final values) are the output of the system 10, and may be considered to be a belief state which is indicative of the phenomenon. Each belief state may be stored or maintained by the sequential data module 30, and the belief state for a given time period affects the output of the system 10 for the next time period. The process described at block 66 is repeated sequentially for each standardized data point.

From block 66, the process advances to block 68, where the feedback learning module 20 receives input (i.e., feedback) regarding the correctness of the output generated by the sequential data module 30. The feedback may be in any suitable form which can indicate, based on the judgment of a user, that the output was correct or indicate that output was incorrect. The feedback learning module 20 utilizes the input to retrain, improve the accuracy of, and/or initiate the replacement of at least one of the following: the model parameters 34 of the sequential data module 30 (including the learned distributions of the respective labels, the transition matrixes, etc.), the standardization module 28, and the respective data sources 22. In general, if the feedback is positive, the system 10 will be retrained and/or improved so that the next time the system 10 receives similar data, the output of the sequential data module 30 will likely have a higher final value for the given label. Conversely, if the feedback is negative, the system 10 will be retrained and/or improved so that the next time the system 10 receives similar data, the output of the sequential data module 30 will likely have a lower final value for the given label.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the claimed invention. For example, some steps of the method 50 may be performed concurrently or in a different order. Accordingly, it is understood that the drawings and the descriptions herein are proffered only to facilitate comprehension of the invention and should not be construed to limit the scope thereof.

What is claimed is:

1. A system for identifying an observed phenomenon, the system comprising:
a computing device configured for receiving disparate data streams associated with disparate data sources:
a feature extraction module communicably connected to the computing device, wherein the feature extraction module is configured for generating a set of attributes for each data stream;
a classification module communicably connected to the computing device, wherein the classification module is configured for:
soft associating labels with attributes for each set of attributes; and
generating a confidence value for each soft association; and
a consensus module communicably connected to the computing device, wherein the consensus module is configured for generating an output indicative of the phenomenon, wherein the consensus module comprises:
a standardization module configured for standardizing the confidence values; and
a sequential data module configured for generating the output based on the standardized confidence values.

2. The system of claim 1, wherein the sequential data module comprises:
a set of model parameters; and
an online estimation module communicably connected to the set of model parameters, wherein the online estimation module is configured for:
receiving the labels and corresponding standardized confidence values; and
generating the output based on the standardized confidence values and a previous output.

3. The system of claim 2, wherein the sequential data module is further configured for maintaining a belief state indicative of the output.

4. The system of claim 1, further comprising a feedback learning module communicably connected to the computing device, wherein the feedback learning module is configured for:
receiving information associated with the output; and
initiating modification of at least one of the following:
the standardization module; and
at least one model parameter of the sequential data module.

5. A method, implemented at least in part by a computing device, for identifying an observed phenomenon, the method comprising:
receiving disparate data streams associated with disparate data sources;
generating a set of attributes for each data stream;
soft associating labels with attributes for each set of attributes generating a confidence value for each soft association;
standardizing the confidence values; and
generating an output indicative of the phenomenon based on the standardized confidence values.

6. The method of claim 5, wherein generating the attributes comprises applying a transform to each data stream.

7. The method of claim 6, wherein applying the transform comprises applying at least one of the following:
a spatial transform;
a temporal transform; and
a frequency-based transform.

8. The method of claim 6, further comprising reducing a dimensionality of at least one of the transformed data streams.

9. The method of claim 8, wherein reducing the dimensionality comprises applying at least one of the following to the at least one of the transformed data streams:
a linear dimensionality reduction algorithm; and
a non-linear dimensionality reduction algorithm.

10. The method of claim 5, wherein soft associating the labels comprises applying at least one of the following to at least one of the attributes:
a parametric classification algorithm; and
a non-parametric classification algorithm.

11. The method of claim 5, wherein generating the confidence values comprises determining a distance of at least one of the labels from a decision boundary.

12. The method of claim 5, wherein standardizing the confidence values comprises, for each data stream, standardizing the confidence values associated with the data stream to a value between zero and one.

13. The method of claim 5, wherein generating the output further comprises generating the output based on a parameter model and a previous output.

14. The method of claim 5, further comprising maintaining a belief state based on the output.

15. The method of claim 5, further comprising receiving feedback regarding the output.

16. The method of claim 15, further comprising at least one of the following based on the received feedback:
modifying a process utilized for the standardization of the confidence values; and
modifying at least one parameter model utilized to generate the output.
